(19) United States
(12) Patent Application Publication
(10) Pub. No.: US 2002/0165879 A1
(43) Pub. Date: Nov. 7, 2002

(54) TD/TDX universal data presentation system and method

(76) Inventors: Jacob Dreyband, Los Gatos, CA (US); Leonid Nilva, San Jose, CA (US)

Correspondence Address: Kevin H. Fortin, BURNS, DOANE, SWECKER & MATHIS, L.L.P., P.O. Box 1404, Alexandria, VA, 22313-1404, US

(21) Appl. No.: 09/735,715

(22) Filed: Dec. 12, 2000

(51) Int. Cl. G06F 9/46; G06F 9/00; G06F 17/24; G06F 17/21; G06F 17/00; G06F 15/00

(52) U.S. Cl. 707/513; 707/526

(57) ABSTRACT

The present invention provides a method for presenting data within a computing environment including an application program interface. The method includes creating a tagged data object for storing data, encapsulating a data element into the tagged data object to provide a tagged data, and packing the tagged data by converting the tagged data into a binary representation of the tagged data. The tagged data includes a corresponding tag id and the encapsulated data element. Another aspect of the present invention includes unpacking a packed tagged data by converting the packed tagged data from a binary representation into a tagged data, creating a tagged data object for storing the tagged data, and extracting a data element from the tagged data.

### BACKGROUND OF THE INVENTION

1. Field of the Invention

The present invention generally relates to data presentation within a computing environment and, more particularly, to a platform independent, hardware architecture independent and language independent data container which provides a wide range of access methods to manipulate and aggregate structured and unstructured data.

2. Description of the Related Art

A document object model is a programming interface specification which allows the programmer to create and modify HTML pages and XML documents as a program object containing the contents and data within the object. Document objects are data containers used in the exchange of data between computing environments.

Currently there are two approaches in the presentation of a document object model. The first approach is a very general language independent method that manipulates the document object by using an ASCI text presentation, such as HTML and XML. The second is a language specific implementation that is narrowly tailored to particular language models.

In order for data to be transmitted and used by different computing systems, the generic first approach converts the data into text, such as an ASCII state, for example. One disadvantage of this general text presentation is that a tremendous amount of memory is used because the data is presented in the form of strings. Another disadvantage is that the processing time required is substantial longer thus resulting in much slower computing times. The decreased speed takes place because of the time required to convert the represented data into data which can be used by internal computing processes. By way of example, when dealing with an integer, the data is transformed from an integer to a string representation in order to be transmitted and then back from a string to the integer after transmission. Thus at least two data presentation transformations are needed with every process which uses large quantities of memory and creates unnecessary time delays.

The second approach is confined to a specific presentation language, such as JDOM for example. The disadvantage of being language specific is that the implementation of the document object model is limited and dependent upon the specific language. For instance, JDOM is limited to a very specific implementation of a J document, the document model for JAVA and could not be used in any other type of environment. As such, every language must have a specific document object model associated with it.

Therefore there remains a need to provide for a document object model that may be used universally among languages while maintaining speed and efficient memory utilization.

### SUMMARY OF THE INVENTION

The present invention overcomes the shortcomings of the prior art by providing a method for presenting data within a computing environment including an application program interface. The method includes creating a tagged data object for storing data, encapsulating a data element into the tagged data object to provide a tagged data, and packing the tagged data by converting the tagged data into a binary representation of the tagged data. The tagged data includes a corresponding tag id and the encapsulated data element.

Another aspect of the present invention provides a method for presenting data within a computing environment including an application program interface. The method includes unpacking a packed tagged data by converting the packed tagged data from a binary representation into a tagged data, creating a tagged data object for storing the tagged data, and extracting a data element from the tagged data.

Yet another embodiment provides a method for presenting data within a computing environment of the type having an application program interface prescribed by a data conversion and a wire formatting specification. The method includes creating a tagged data object, encapsulating a data element into the tagged data object to provide a tagged data, packing the tagged data into a binary representation to provide a tagged data transmission, transmitting the tagged data transmission, unpacking the tagged data transmission from the binary representation to retrieve the tagged data, and extracting the data element from the tagged data. The tagged data object may be a universal data container that is platform independent, hardware architecture independent and language independent. The tagged data object may provide broad access to the manipulation and aggregation of data, for example structured data and unstructured data. Upon encapsulation, the tagged data object includes a corresponding tag identifier and the data element.

For a better understanding of the present invention, together with other and further objects thereof, reference is made to the following description, taken in conjunction with the accompanying drawings, and its scope will be defined in the appending claims.

### BRIEF DESCRIPTION OF THE DRAWINGS

FIG. 1 is a flowchart describing a method for presenting data within a computing environment including an application program interface;

FIG. 2 is a flowchart describing a method for packing a simple object;

FIG. 3 is a flowchart describing a method for packing a complex object;

FIG. 4 is a flowchart describing a method for packing a list object;

FIG. 5 is a flowchart describing a method for encapsulating a data element;

FIG. 6 is a flowchart describing a method for presenting data within a computing environment including an application program interface;

FIG. 7 is a flowchart describing a method for unpacking a simple object;

FIG. 8 is a flowchart describing a method for unpacking a complex object;

FIG. 9 is a flowchart describing a method for unpacking a list object;

FIG. 10 is a flowchart describing a method for extracting a data element form the tagged data; and

FIG. 11 is a flowchart describing a method for presenting data within a computing environment of the type having an application program interface prescribed by a data conversion and a wire formatting specification.

### DETAILED DESCRIPTION OF THE INVENTION

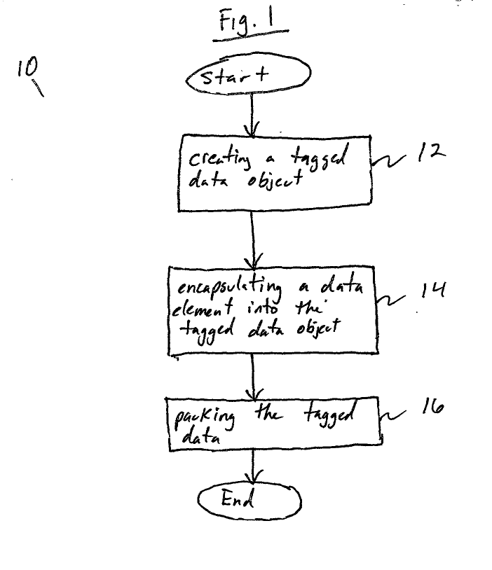

In accordance with the presently claimed invention, a method is provided which combines the generic approach of the general HTML/XML method with a more efficient and faster speed than that of an environment specific presentation. FIG. 1 is a flowchart describing a method for presenting data within a computing environment including an application program interface and is generally designated by the numeral 10. The method 10 begins by creating a tagged data object, as indicated at 12. The first step is taking pieces of data and converting those pieces of data into a TD internal data representation. The tagged data object may optionally be a composite of three types: a shell object, a complex object and a list object. The shell object may store primitive data types. An example of some of the types of primitive data may be as follows: an integer, a float, a byte value, a character sequence, a null value, binary data, a string, XML text, a java object, a Td Object, a C/C++ data object, and a data object. The shell object may be a data wrap around. The complex object may be a named tree storing elements under a field name which may be connected to a value. The complex object value may include a shell object. The list object may be a combination between the shell object and the complex object. Thus, when the tagged data object is created, the type of object to be created is determined based upon the type of data to be encapsulated.

After recognizing the type of data, said data is then encapsulated into the data object, as indicated at 14. Optionally, the number of data sequences to be tagged may be determined before converting a particular value to the tagged data structure. The tagged data is labeled data that is physically written into a specific form. By way of example, encapsulating data into a tagged data simple object could be defined as follows: TdObject x=new TdObject (500), where 500 is an integer value.

Another example would be encapsulating data into a tagged complex object for a structure called “Employee” with field names “Last Name”, “First Name”, and “Salary”. As such, the tagged data complex object may be defined as follows:

TdObject emp=new TdObject (“Employee”);

emp.add Field (“Last Name”, “Smith”);

emp.add Field (“First Name”, “Mike”);

emp.add Field (“Salary”, 60,000);

By way of example, a list object may be defined as follows: TdObject y=new TdObject ( ); y.add Object (emp); y.add Object (x).

The sequence of data is tagged which enables the computer to recognize exactly what type of data is being represented and how many bytes the computer should read after the tag, depending on the type of data. Next, method 10 packs the tagged data into a binary representation, as indicated at 16. The binary representation may be a wire format which enables the object to be transferred from one computing environment to another. Instead of having to convert the data into a string representation such as ASCII in an HTML/XML approach, the instant invention converts the tagged data into a binary representation of the tagged data object when wire formatting. Optionally, this may be done by identifying the byte as follows: byte[ ] data=emp.pack ( ) which may return back an array.

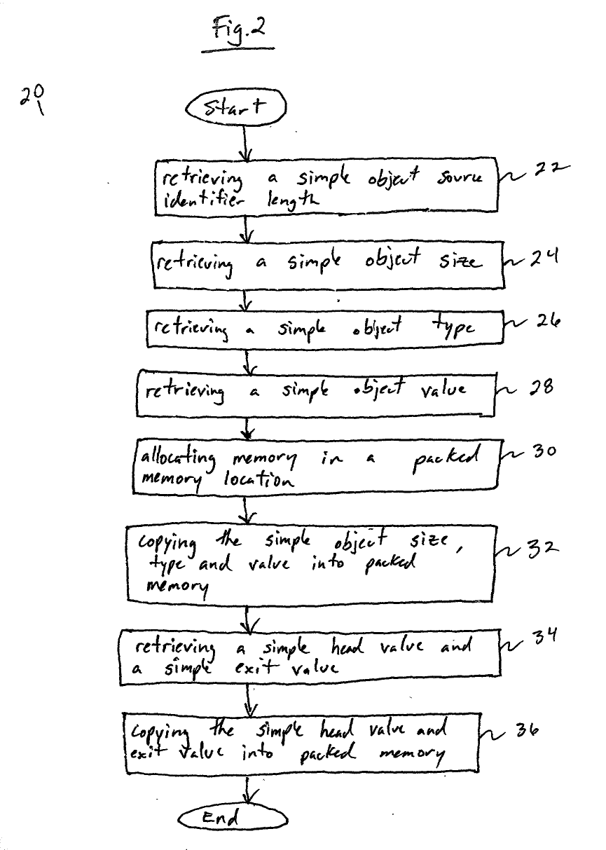

FIG. 2 is a flowchart describing a method for packing a simple object and is generally designated by the numeral 20. Method 20 begins with retrieving a simple object source identifier length, as indicated at 22. The simple object size is retrieved, as indicated at 24. Next the simple object type is read, as indicated at 26. Then the simple object value is acquired, as indicated at 28. A section of packed memory is then allocated to accommodate the length of the simple object by using the simple object source identifier, as indicated at 30. The simple object size, type and value are then copied to the packed memory location, as indicated at 32. Once the simple head value and the simple exit value of the packed memory location are acquired, as indicated at 34, those values are then written into the packed memory location, as indicated at 36.

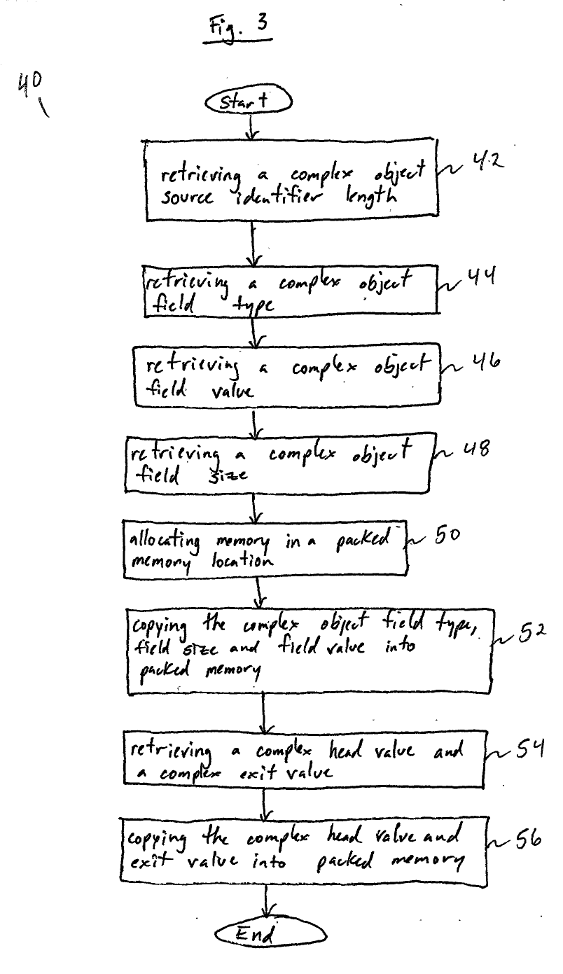

FIG. 3 is a flowchart describing a method for packing a complex object and is generally designated by the numeral 40. Method 40 begins with retrieving a complex object source identifier length, as indicated at 42. The complex object field type is retrieved, as indicated at 44. Next the complex object field value is read, as indicated at 46. This field value may be a simple object. Then the complex object field value is acquired, as indicated at 48. A section of packed memory is then allocated to accommodate the length of the complex object by using the complex object source identifier, as indicated at 50. The complex object field type, size and value are then copied to the packed memory location, as indicated at 52. Once the complex head value and the complex exit value of the packed memory location are acquired, as indicated at 54, those values are then written into the packed memory location, as indicated at 56.

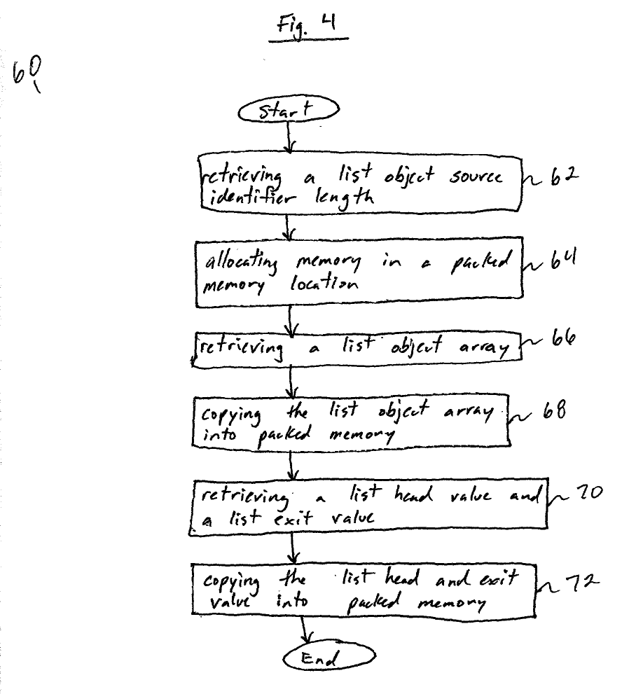

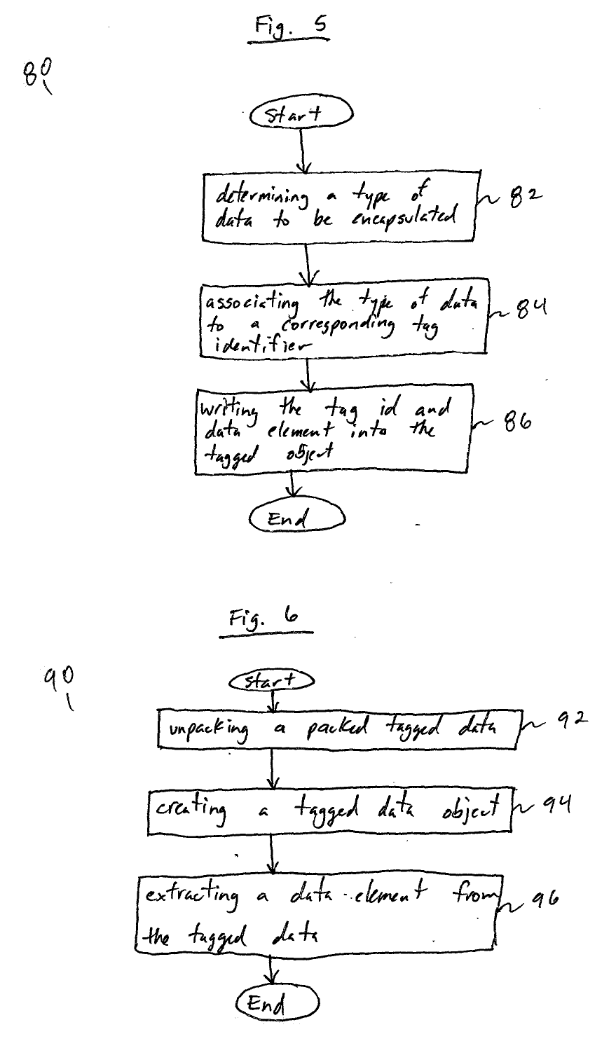

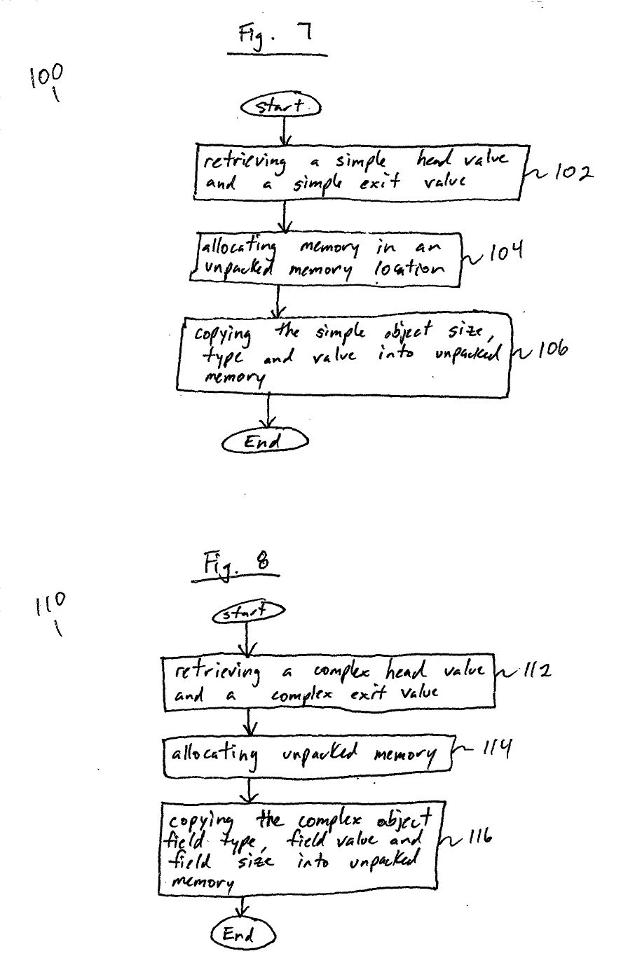

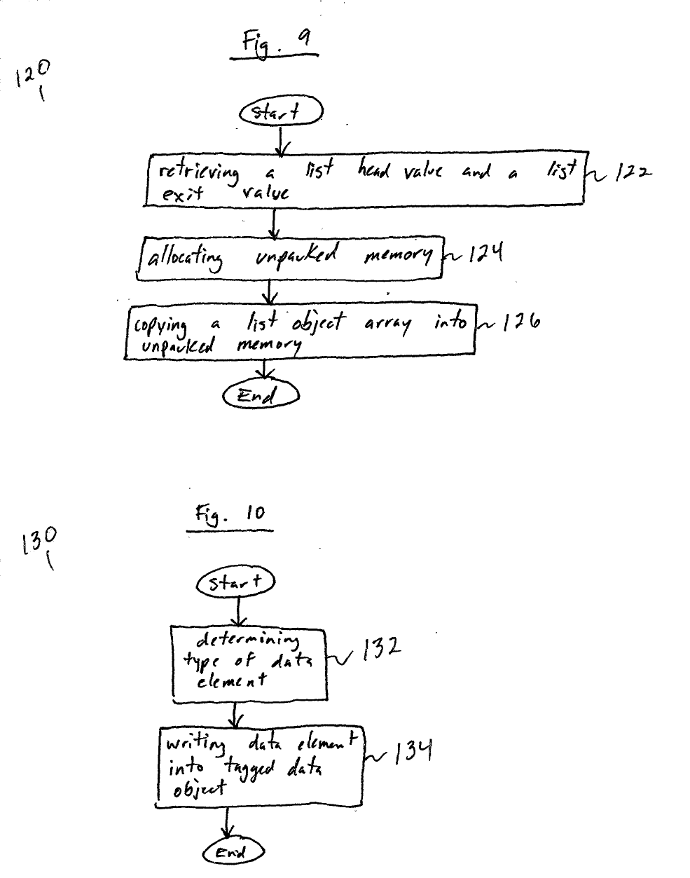

FIG. 4 is a flowchart describing a method for packing a list object and is generally designated by the numeral 60. Method 60 begins with retrieving a list object source identifier length, as indicated at 62. Next a section of packed memory is allocated to accommodate the length of the list object by using the list object source identifier, as indicated at 64. A list object array is then retrieved, as indicated at 66. The list object array is copied into the packed memory location, as indicated at 68. Next the list head value and the list exit value of the packed memory location are acquired, as indicated at 70, and those values are then written into the packed memory location, as indicated at 72.

FIG. 5 is a flowchart describing a method for encapsulating a data element and is generally designated by the numeral 80. Method 80 begins by determining the type of data to be encapsulated, as indicated at 82. The type of data may include an integer, a float numeric value, a one byte value, a character string, a zero terminated character sequence, a byte sequence, a binary data, a null value, a java object, a TD object, an XML text object, a simple (primitive) data type, a compound data type, and a list data type having a combination of data types. Once the data is characterized, the data is then associated with a corresponding tag identifier, as indicated at 84. By way of example, the tag identifiers may include TD_short, TD_ushort, TD_long, TD_ulong, TD_float, TD_double, TD_byte, TD_cstring, TD_blob, TD_null, TD_llong, TD_longstr, TD_java_object, TD_object and TD_xmlstr.

Optionally, the following definitions may correspond to the above mentioned examples of tag identifiers:

TD_SHORT: identifies signed short integer that occupies 2 bytes;

TD_USHORT: identifies unsigned short integer that occupies 2 bytes;

TD_LONG: identifies signed long integer that occupies 4 bytes;

TD_ULONG: identifies unsigned long integer that occupies 4 bytes;

TD_FLOAT: identifies signed float numeric value (with decimal point) that occupies 4 bytes;

TD_DOUBLE: identifies signed float numeric value (with decimal point) of double precision that occupies 8 bytes;

TD_BYTE: identifies any one byte value;

TD_CSTRING: identifies any zero terminated character sequence to support compatibility with C/C++;

TD_BLOB: identifies any byte sequence/binary data;

TD_NULL: identifies null value (no value);

TD_LLONG: identifies signed long integer of double precision that occupies 8 bytes;

TD_LONGSTR: identifies long zero terminated character sequence longer than 256 bytes to provide compatibility with long strings in a database;

TD_JAVA_OBJECT: identifies any java object;

TD_OBJECT: identifies any TdObject; and

TD_XMLSTR: identifies any character sequence than may be interpreted as XML text.

Next the tag identifier and the data element are written into the tagged object, as indicated at 86. For example, this can be done by add(data,position,TD). By way of example, writing tagged data for an integer includes an integer tag and an integer value. The tagged data representation may be represented by <<int>,i> where the “int” is the integer tag and the “i” is the integer value. Another example of tagged data would be a float tagged data which includes a float tag “float” and a float value “f” and may be represented as <<float>,f>. In another example, a string tagged data may be represented as <<string,l>s>where “string” is the string tag, “l” is the string length and “s” is the string value.

FIG. 6 is a flowchart describing a method for presenting data within a computing environment including an application program interface and is generally designated by the numeral 90. Method 90 begins with unpacking a packed tagged data, as indicated at 92. Next a tagged data object is created for the storage of the tagged data once the data is retrieved, as indicated at 94. The tagged data object created corresponds to the type of packed tagged data. By way of example, the type of packed data may include a simple type, a complex type, and a list type. Finally, the data element is extracted from the tagged data and placed into the tagged data object, as indicated at 96.

FIG. 7 is a flowchart describing a method for unpacking a simple object and is generally designated by the numeral 100. A simple head value of the packed simple object and a simple exit value of the packed simple object are retrieved, as indicated at 102. The simple head value is the starting point of the simple object in the transmitted binary representation. The simple exit value is the ending point of the simple object in the binary representation. Next a section of unpacked memory is allocated to accommodate the simple object, as indicated at 104. Finally, from the packed binary representation, the simple object size, type and value are copied into the unpacked memory location, as indicated at 106.

FIG. 8 is a flowchart describing a method for unpacking a complex object and is generally designated by the numeral 110. A complex head value of the packed complex object and a complex exit value of the packed complex object are retrieved, as indicated at 112. The complex head value is the starting point of the complex object in the transmitted binary representation. The complex exit value is the ending point of the complex object in the binary representation. Next a section of unpacked memory is allocated to accommodate the complex object, as indicated at 114. Finally, from the packed binary representation, the complex object type, value and size are copied into the unpacked memory location, as indicated at 116.

FIG. 9 is a flowchart describing a method for unpacking a list object and is generally designated by the numeral 120. A list head value of the packed list object and a list exit value of the packed list object are retrieved, as indicated at 122. The list head value is the starting point of the list object in the transmitted binary representation. The list exit value is the ending point of the list object in the binary representation. Next a section of unpacked memory is allocated to accommodate the list object, as indicated at 124. Finally, from the packed binary representation, the list object array is copied into the unpacked memory location, as indicated at 126.

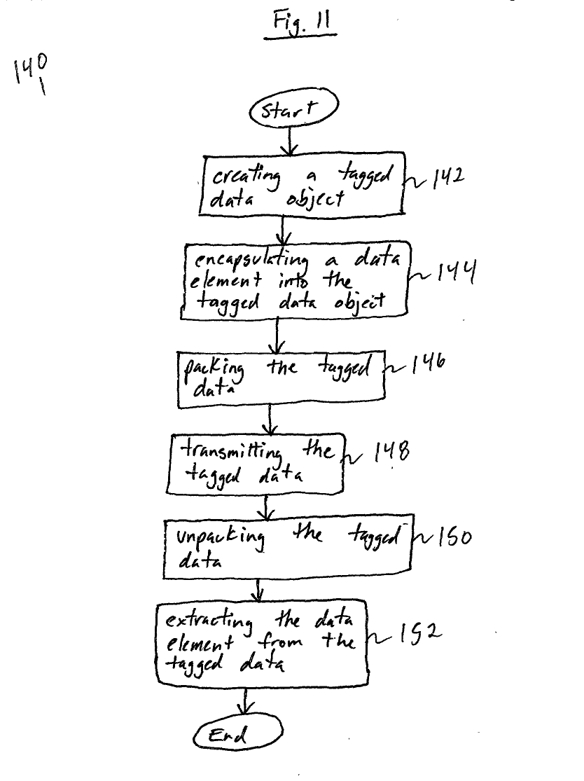

FIG. 10 is a flowchart describing a method for extracting a data element form the tagged data and is generally designated by the numeral 130. Method 10 begins with determining the type of data element contained within the tagged data, as indicated as 132. By way of example, a command such as query may return the data type. Optionally, query (TD, position) would return a tagged data type associated with the given position. Next, the data element is written into the tagged data object, as indicated at 134. A data value may be extracted by extract (TD, position) in order to be written into the tagged data object.

FIG. 11 is a flowchart describing a method for presenting data within a computing environment of the type having an application program interface prescribed by a data conversion and a wire formatting specification and is generally designated by the numeral 140. Method 140 begin with creating a tagged data object, as indicated at 142. Optionally, the tagged data object may be a universal data container that is platform independent, hardware architecture independent and language independent. The tagged data object may provide broad access to the manipulation and aggregation of structured data and unstructured data. Next a data element is encapsulated into the tagged data object, as indicated at 144. The encapsulation may provide tagged data which may include a corresponding tag identifier and the data element. The tagged data is labeled data that is physically written into a specific form. The tagged data is then packed into a wire format for transmission by converting the tagged data into a binary representation of the tagged data, as indicated at 146. Then the tagged data is transmitted, as indicated at 148. The tagged data is unpacked, as indicated at 150. Finally the data is extracted from the tagged data, as indicated at 152.

While there has been described what are believed to be the exemplary embodiments of the present invention, those skilled in the art will recognize that other and further changes and modifications may be made thereto without departing from the scope of the invention which is defined by the appended claims, and it is intended to claim all such changes and modifications as fall within the true scope of the invention.

1. A method for presenting data within a computing environment including an application program interface, said method comprising the steps of:
creating a tagged data object for storing data;
encapsulating a data element into the tagged data object to provide a tagged data, wherein said tagged data includes a corresponding tag id and said data element; and
packing the tagged data by converting the tagged data into a binary representation of the tagged data.

2. The method as recited in claim 1, wherein packing the tagged data comprises one of the following steps: packing a simple object, packing a complex object, and packing a list object.

3. The method as recited in claim 2, wherein packing the simple object comprises the steps of:
retrieving a simple object source identifier length;
retrieving a simple object size;
retrieving a simple object type;
retrieving a simple object value;
allocating memory in a packed memory location to accommodate the simple object source identifier length;
copying the simple object size, the simple object type and the simple object value into the packed memory location;
retrieving a simple head value and a simple exit value of the packed memory location; and
copying the simple head value and the simple exit value into the packed memory location.

4. The method as recited in claim 2, wherein packing the complex object comprises the steps of:
retrieving a complex object source identifier length;
retrieving a complex object field type;
retrieving a complex object field value;
retrieving a complex object field size;
allocating memory in a packed memory location to accommodate the complex object source identifier length;
copying the complex object field type, the complex object field value, and the complex object field size into the packed memory location;
retrieving a complex head value and a complex exit value of the packed memory location; and
copying the complex head value and the complex exit value into the packed memory location.

5. The method as recited in claim 4, wherein the complex object field value is a simple object.

6. The method as recited in claim 2, wherein packing the list object comprises the steps of:
retrieving a list object source identifier length;
allocating memory in a packed memory location to accommodate the list object source identifier length;
retrieving a list object array;
copying the list object array into the packed memory location;
retrieving a list head value and a list exit value of the packed memory location; and
copying the list head value and the list exit value into the packed memory location.

7. The method as recited in claim 6, wherein the list object array comprises a simple object and a complex object.

8. The method as recited in claim 1, wherein the tagged data object is a universal data container that is platform independent, hardware architecture independent and language independent, said tagged data object to provide broad access to manipulation and aggregation of a structured data and an unstructured data.

9. The method as recited in claim 1, wherein the method further includes the step of transmitting the binary representation of the tagged data.

10. The method as recited in claim 1, wherein the tagged data object comprises one of a simple data object, a complex data object, and a list data object.

11. The method as recited in claim 10, wherein the simple data object comprises a simple data wrap around.

12. The method as recited in claim 10, wherein the complex data object comprises a named tree including a data storage having a field name connected with a value.

13. The method as recited in claim 10, wherein the list data object comprises a combination of the simple data object and the complex data object.

14. The method as recited in claim 1, wherein encapsulating the data element comprises the steps of:
determining a type of data to be encapsulated;
associating said type of data to the corresponding tag id; and
writing said corresponding tag id and said data element into the tagged data object.

15. The method as recited in claim 14, wherein the type of data comprises one of the following: an integer, a float numeric value, a one byte value, a character string, a zero terminated character sequence, a byte sequence, a binary data, a null value, a java object, a TD object, an XML text object, a primitive data type, a compound data type, and a list data type having a combination of data types.

16. The method as recited in claim 14, wherein the corresponding tag id comprises one of the following: short, ushort, long, ulong, float, double, byte, cstring, blob, null, llong, longstr, java_object, object and xmlstr.

17. The method as recited in claim 1, wherein the method further comprises the step of determining a number of data sequences to be tagged.

18. The method as recited in claim 1, wherein encapsulating the data element comprises the step of adding to the tagged data object the following: a data, a position and a tag data element.

19. The method as recited in claim 1, wherein prior to packing the tagged data, the tagged data object is transformed from a first type to a second type to provide for a change in properties.

20. The method as recited in claim 19, wherein the first type comprises one of a simple object, a complex object, a list object, a multiplicity of simple objects, a multiplicity of complex objects and a multiplicity of list objects.

21. The method as recited in claim 19, wherein the second type comprises one of a simple object, a complex object, a list object, a multiplicity of simple objects, a multiplicity of complex objects and a multiplicity of list objects.

22. A method for presenting data within a computing environment including an application program interface, said method comprising the steps of:
unpacking a packed tagged data by converting the packed tagged data from a binary representation into a tagged data;
creating a tagged data object for storing the tagged data; and
extracting a data element from the tagged data.

23. The method as recited in claim 22, wherein unpacking the packed tagged data comprises one of the following steps: unpacking a simple object, unpacking a complex object, and unpacking a list object.

24. The method as recited in claim 23, wherein unpacking the simple object comprises the steps of:
retrieving a simple head value and a simple exit value to provide a simple object source identifier length;
allocating memory in an unpacked memory location to accommodate the simple object source length; and
copying a simple object size, a simple object type and a simple object value into the unpacked memory location.

25. The method as recited in claim 23, wherein unpacking the complex object comprises the steps of:
retrieving a complex head value and a complex exit value to provide a complex object source identifier length;
allocating memory in an unpacked memory location to accommodate the complex object source length; and
copying a complex object field type, a complex object field value and a complex object field size into the unpacked memory location.

26. The method as recited in claim 25, wherein the complex object field value comprises a simple object.

27. The method as recited in claim 23, wherein unpacking the list object comprises the steps of:
retrieving a list head value and a list exit value to provide a list object source identifier length;
allocating memory in an unpacked memory location to accommodate the list object source length; and
copying a list object array into the unpacked memory location.

28. The method as recited in claim 27, wherein the list object array comprises a simple object and a complex object.

29. The method as recited in claim 22, wherein the method further comprises the step of determining a number of data sequences that have been tagged.

30. The method as recited in claim 22, wherein extracting the data element from the tagged data comprises the steps of:
determining the type of said data element to provide a tag id; and
writing the data element into the tagged data object.

31. The method as recited in claim 30, wherein the type of data comprises of one of the following: an integer, a float numeric value, a one byte value, a character string, a zero terminated character sequence, a byte sequence, a binary data, a null value, a java object, a TD object, an XML text object, a primitive data type, a compound data type, and a list data type having a combination of data types.

32. The method as recited in claim 30, wherein the corresponding tag id comprises of one of the following: short, ushort, long, ulong, float, double, byte, cstring, blob, null, llong, longstr, java_object, object and xmlstr.

33. The method as recited in claim 30, wherein writing the data element into the tagged data object comprises the step of adding a data, a position and a tag data element to the tagged data object.

34. The method as recited in claim 22, wherein the tagged data object comprises a universal data container that is platform independent, hardware architecture independent and language independent, said tagged data object to provide broad access to manipulation and aggregation of a structured data and an unstructured data.

35. The method as recited in claim 22, wherein the method further includes the step of receiving the binary representation of the tagged data.

36. The method as recited in claim 22, wherein the tagged data object comprises one of a simple data object, a complex data object, and a list data object.

37. The method as recited in claim 36, wherein the simple data object comprises a simple data wrap around.

38. The method as recited in claim 36, wherein the complex data object comprises a named tree including a data storage having a field name connected with a value.

39. The method as recited in claim 36, wherein the list data object comprises a combination of the simple data object and the complex data object.

40. The method as recited in claim 22, wherein the tagged data object is transformed from a first type to a second type to provide for a change in properties.

41. The method as recited in claim 40, wherein the first type comprises one of a simple object, a complex object, a list object, a multiplicity of simple objects, a multiplicity of complex objects and a multiplicity of list objects.

42. The method as recited in claim 40, wherein the second type comprises one of a simple object, a complex object, a list object, a multiplicity of simple objects, a multiplicity of complex objects and a multiplicity of list objects.

43. A method for presenting data within a computing environment of the type having an application program interface prescribed by a data conversion and a wire formatting specification, said method comprising the steps of:
creating a tagged data object, wherein the tagged data object comprises a universal data container that is platform independent, hardware architecture independent and language independent, said tagged data object to provide broad access to manipulation and aggregation of a structured data and an unstructured data;
encapsulating a data element into the tagged data object to provide a tagged data, wherein said tagged data includes a corresponding tag id and said data element;
packing the tagged data to provide a tagged data transmission by converting the tagged data into a binary representation of the tagged data;
transmitting the tagged data transmission;
unpacking the tagged data transmission by converting the tagged data transmission from the binary representation into the tagged data; and
extracting the data element from the tagged data.

44. The method as recited in claim 43, wherein packing the tagged data comprises one of the following steps: packing a simple object, packing a complex object, and packing a list object.

45. The method as recited in claim 44, wherein packing the simple object comprises the steps of:
retrieving a simple object source identifier length;
retrieving a simple object size;
retrieving a simple object type;
retrieving a simple object value;
allocating memory in a packed memory location to accommodate the simple object source identifier length;
copying the simple object size, the simple object type and the simple object value into the packed memory location;
retrieving a simple head value and a simple exit value of the packed memory location; and
copying the simple head value and the simple exit value into the packed memory location.

46. The method as recited in claim 44, wherein packing the complex object comprises the steps of:
retrieving a complex object source identifier length;
retrieving a complex object field type;
retrieving a complex object field value;
retrieving a complex object field size;
allocating memory in a packed memory location to accommodate the complex object source identifier length;
copying the complex object field type, the complex object field value, and the complex object field size into the packed memory location;
retrieving a complex head value and a complex exit value of the packed memory location; and
copying the complex head value and the complex exit value into the packed memory location.

47. The method as recited in claim 46, wherein the complex object field value comprises a simple object.

48. The method as recited in claim 44, wherein packing the list object comprises the steps of:
retrieving a list object source identifier length;
allocating memory in a packed memory location to accommodate the list object source identifier length;
retrieving a list object array;
copying the list object array into the packed memory location;
retrieving a list head value and a list exit value of the packed memory location; and
copying the list head value and the list exit value into the packed memory location.

49. The method as recited in claim 48, wherein the list object array comprises a simple object and a complex object.

50. The method as recited in claim 43, wherein unpacking the packed tagged data comprises one of the following steps: unpacking a simple object, unpacking a complex object, and unpacking a list object.

51. The method as recited in claim 50, wherein unpacking the simple object comprises the steps of:
retrieving a simple head value and a simple exit value to provide a simple object source identifier length;
allocating memory in an unpacked memory location to accommodate the simple object source length; and
copying a simple object size, a simple object type and a simple object value into the unpacked memory location.

52. The method as recited in claim 50, wherein unpacking the complex object comprises the steps of:
retrieving a complex head value and a complex exit value to provide a complex object source identifier length;
allocating memory in an unpacked memory location to accommodate the complex object source length; and
copying a complex object field type, a complex object field value and a complex object field size into the unpacked memory location.

53. The method as recited in claim 52, wherein the complex object field value comprises a simple object.

54. The method as recited in claim 50, wherein unpacking the list object comprises the steps of:
retrieving a list head value and a list exit value to provide a list object source identifier length;
allocating memory in an unpacked memory location to accommodate the list object source length; and
copying a list object array into the unpacked memory location.

55. The method as recited in claim 54, wherein the list object array comprises a simple object and a complex object.

56. The method as recited in claim 43, wherein the tagged data object comprises one of a simple data object, a complex data object, and a list data object.

57. The method as recited in claim 56, wherein the simple data object comprises a simple data wrap around.

58. The method as recited in claim 56, wherein the complex data object comprises a named tree including a data storage having a field name connected with a value.

59. The method as recited in claim 56, wherein the list data object comprises a combination of the simple data object and the complex data object.

60. The method as recited in claim 43, wherein encapsulating the data element comprises the steps of:
determining a type of data to be encapsulated;
associating said type of data to the corresponding tag id; and
writing said corresponding tag id and said data element into the tagged data object.

61. The method as recited in claim 60, wherein the type of data comprises one of the following: an integer, a float numeric value, a one byte value, a character string, a zero terminated character sequence, a byte sequence, a binary data, a null value, a java object, a TD object, an XML text object, a primitive data type, a compound data type, and a list data type having a combination of data types.

62. The method as recited in claim 60, wherein the corresponding tag id comprises one of the following: short, ushort, long, ulong, float, double, byte, cstring, blob, null, llong, longstr, java_object, object and xmlstr.

63. The method as recited in claim 43, wherein the method further comprises the step of determining a number of data sequences to be tagged.

64. The method as recited in claim 43, wherein encapsulating the data element comprises the step of adding a data, a position and a tag data element to the tagged data object.

65. The method as recited in claim 43, wherein the tagged data object is transformed from a first type to a second type to provide for a change in properties.

66. The method as recited in claim 65, wherein the first type comprises one of a simple object, a complex object, a list object, a multiplicity of simple objects, a multiplicity of complex objects and a multiplicity of list objects.

67. The method as recited in claim 65, wherein the second type comprises one of a simple object, a complex object, a list object, a multiplicity of simple objects, a multiplicity of complex objects and a multiplicity of list objects.

68. The method as recited in claim 43, wherein extracting the data element from the tagged data comprises the steps of:
determining the type of said data element to provide a corresponding tag id; and
writing the data element into the tagged data object.

69. The method as recited in claim 68, wherein the type of data comprises one of the following: an integer, a float numeric value, a one byte value, a character string, a zero terminated character sequence, a byte sequence, a binary data, a null value, a java object, a TD object, an XML text object, a primitive data type, a compound data type, and a list data type having a combination of data types.

70. The method as recited in claim 68, wherein the corresponding tag id comprises of one of the following: short, ushort, long, ulong, float, double, byte, cstring, blob, null, llong, longstr, java_object, object and xmlstr.

71. The method as recited in claim 68, wherein writing the data element into the tagged data object comprises the step of adding a data, a position and a tag data element to the tagged data object.
